(19) United States
(12) Patent Application Publication
(10) Pub. No.: US 2023/0042350 A1
(43) Pub. Date: Feb. 9, 2023

(54) SYSTEM AND METHOD FOR IMPROVING QUALITY ASSURANCE PROCESS IN CONTACT CENTERS

(71) Applicant: NICE Ltd., Ra’anana (IL)

(72) Inventors: Abhijit Mokashi, Pune (IN); Onkar Hingne, Pune (IN)

(73) Assignee: NICE Ltd., Ra’anana (IL)

(21) Appl. No.: 17/376,565

(22) Filed: Jul. 15, 2021

(51) Int. Cl. G06Q 10/06

(52) U.S. Cl. CPC G06Q 10/06398; G06Q 10/063114

(57) ABSTRACT

Embodiments of the invention are directed to a computer-implemented system and method of performing quality assurance. The method may include receiving, by a processor, a quality plan comprising an expected number of evaluation tasks, wherein each evaluation task is distributed to an evaluator of a plurality of evaluators to be completed. For each evaluator, the processor computes an expected number of evaluation tasks to be completed per period, wherein the expected number of evaluation tasks completed per period is based on the expected number of evaluation tasks averaged over a set time period. The processor receives, for each evaluator, a number of actual evaluation tasks completed during the set time period and reassigns one or more evaluation tasks from the evaluator if the actual evaluation tasks completed during the set time period for said evaluator does not meet a predetermined threshold.

### FIELD OF THE INVENTION

Embodiments of the invention are directed to a computer-implemented method of performing quality assurance.

### BACKGROUND OF THE INVENTION

Many companies, businesses or organizations operate or use a centralized communication center, such as a call center or contact center to handle incoming and outgoing interactions with clients, customers, constituents, members or users. For example, government agencies, healthcare facilities, banking institutions, companies and/or any business which may include telemarketing methods, product services, surveys, debt collection and customer support. Call centers provide an effective and convenient way for clients to solve problems or address their needs.

Quality management of contact or call centers is recognized as an invaluable tool for maintaining and increasing performance, efficiency and productivity, among other aspects, of such facilities. Various operational or other aspects of a call center may be relevant to a quality management process. For example, customer experience and/or satisfaction, calls duration, outcome or other parameters, number of interactions per a time period may all be relevant to the control, assurance and/or improvements of quality and accordingly, to quality management.

Typically, quality management includes evaluating calls or interactions to enrich the feedback provided to call center agents during coaching sessions and enhance the agent's motivation to improve their performance. Evaluation of interactions have quickly become an invaluable tool to enhance the transparency and consistency of quality assurance practices within the call center. For example, an evaluator such as a quality manager or supervisor may replay a recording of a call held between an agent and a customer and evaluate the call, possibly taking into account parameters such as the outcome of the call, the duration of the call, the level of satisfaction of the customer and so on. Typically the agent and customer are both people. The call may be any sort of communication, and possibly a combination of communications over different channels or modes, such as telephone, voice-over-IP (VoIP), chat, text, video call, or other methods.

As part of quality management, a plan may be created which outlines a target that a certain number of evaluation tasks should be performed in a given period of time and specifies the evaluators participating in the quality plan. In a quality plan, a quality manager or supervisor (e.g. evaluator) may be required to search for or be distributed interactions as part of an evaluation task. For example, evaluators may receive or search for interactions from a pool or supply of interactions to evaluate, and this pool or supply may be divided among the evaluators in the quality plan. The quality plan may be managed by a quality plan manager and may set targets and criteria, among other things, for the quality plan. One prior method for quality planning uses the selection and evaluation of an interaction by an evaluator as part of a quality plan. However, current quality plans do not guarantee success nor offer an ability to correct the plan if the plan is going off-track. Manually and continuously managing quality plans is both a time-consuming and a tedious task as and is prone to human-error. This results in a failure of the quality management process as a result of the inability of quality plans to meet their targets. Therefore, there is a need for an improvement in the effectiveness and stability of the quality assurance process.

### SUMMARY

A system and method may perform quality assurance for evaluators on a quality plan. Using a computer implemented method, a quality plan including an expected number of evaluation tasks may be received or gathered. The evaluation tasks may be distributed to an evaluator of a plurality of evaluators to be completed. For each evaluator, an average forecasted evaluation task completion rate may be computed based on the historical evaluation tasks completed by the evaluator averaged over a period of time. The evaluators may be reassigned one or more evaluation tasks if the forecasted evaluation task completion rate for the evaluator does not meet a predetermined threshold.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is an exemplary block diagram of a quality management system with a quality planner according to embodiments of the present invention.

FIG. 2 is an exemplary block diagram of a quality planner system according to embodiments of the invention.

FIG. 3A is a flow diagram of the search filter analysis algorithm as part of a preventive forecast engine according to embodiments of the present invention.

FIG. 3B is a flow diagram of the evaluator performance forecast algorithm as part of a preventive forecast engine according to embodiments of the present invention.

FIG. 4 is a flow diagram of the preventive forecast engine according to embodiments of the present invention.

FIG. 5 is flow diagram of the proactive correction algorithm according to embodiments of the present invention.

FIG. 6 is a detailed flow diagram of the proactive correction algorithm according to embodiments of the present invention.

FIG. 7 is a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of devices” may include two or more devices.

Although embodiments of the invention are not limited in this regard, the term “contact center” as used herein may be used throughout the specification and claims to describe any centralized or distributed location used for collective handling of multi-media information or interactions, for example, telephone calls, faxes, e-mails, chat, text, video and the like, or any other centralized or distributed locations used for the purpose of receiving, transmitting and controlling a large volume of information including customer-agent communications.

Although embodiments of the invention are not limited in this regard, the terms “call”, “session” and/or “interaction” as used herein may be used throughout the specification and claims to describe a communication session between two or more humans or components, for example, a call or interaction may involve a device or component of a recording environment such as, VoIP telephone call, an instant messaging session, computer screen data, chat, video conference or any other multi-media session or interaction in a multi-media communication environment. Although embodiments of the invention are not limited in this regard, the terms “quality manager” and/or “quality supervisor” as used herein may be used throughout the specification and claims to describe a person who is assigned the task of evaluating interactions. The term “agent” may refer to any person who is assigned the task of interacting with customers, clients or others who may call or otherwise interact with the relevant organization, facility, institution or business. A quality manager may select or search for (“pull”) or be provided, by the processor (“pushed”), calls or recorded interactions for evaluation.

Evaluation tasks may include a human evaluator rating or evaluating an interaction in which an agent participated, and may include receiving an agent's interaction (e.g. provide interactions to the evaluator—“pushed” or search for interactions—“pulled” interactions) and answering questions, for example by the evaluator entering information to a computer, into a premade form. Other methods of evaluation may be used. An evaluation task may be performed, for example, by reviewing (e.g. a human evaluator listens to an interaction received from a server, or automatically, via a computer) in order to gauge, for example, in the context of a call center, agent demeanor and customer satisfaction, such as whether or not the problem raised by the customer the agent was communicating with was successfully resolved by the agent, etc. For example, selected calls may be replayed and evaluated by the quality manager and a score (e.g. 1 to 10 rating scale, with 10 being most satisfied and 1 being dissatisfied) may be associated with the evaluated interaction and/or the relevant agent for how well an agent remedied a customer's problem as well as how satisfied the customer was with the interaction experience. Evaluations may be done collaboratively, for example, an evaluator may receive an agent's interaction to replay and then answer or score questions on a premade form, while simultaneously, the agent may receive their own interaction and perform a self-assessment, using the same premade form. Seen below is an example evaluation entity shown in Javascript programming language in a JSON format; other formats may be used:

Evaluation Entity

```
{
  “evaluation_id”:“87342472-9832-6522-ad24-jh2652jh45”,
  “tenant_id”:“iuj238h2-kj29-kj23-j23k-iou2o3iu3222”,
  “interaction_id”:“78346387-9838-k3kj-98jj-3489757889”,
  “agent_id”:74891748971,
  “evaluator_id”:312133123123,
  “evaluation_time”:“2020-11-10 12:34:55.668 Z”,
  “evaluation_score”:75.00,
  “shift”:“DAY”,
  “evaluation_details”:[
    {
      “question”:“Did the agent greet the customer?”,
      “answer” : “Yes”,
      “score” : 1,
      “maxPossibleScore” : 1,
      “remarks”:null
    },
    {
      “question”:“Did the agent identify the customer?”,
      “answer” : “Partially”,
      “score” : 1,
      “maxPossibleScore” : 2,
      “remarks” : “agent did not ask to confirm address”
    }
  ]
}
```

As shown in the above evaluation entity describing an evaluation task, evaluation details may include a question, an answer, a score, and remarks that the evaluator may note about the agent. Other information may be included.

As described herein, a quality plan may include, for example, the details of which interactions to pick, based on selected filters, and which evaluators to assign the interaction for conducting the evaluation as well as the frequency of the plan. A quality plan may be on-track, meeting evaluation targets, or off-track, not meeting evaluation targets. A quality plan may be managed by a quality plan manager, for example a user responsible for the oversight of the quality plan.

A quality plan may have a name attribute to identify the quality plan. The name attribute may classify a class or a category in a given context related to the quality plan. For example, a quality plan may be named according to the format of the interactions which it filters (e.g. chat).

A quality plan may include a list of evaluators which may be assigned evaluation tasks whereby evaluators evaluate selected interactions. The list of evaluators may include a primary list as well as a reserve pool or supply of evaluators for supplementary use in the situation wherein the primary list is exhausted. For example, primary evaluators may be on leave or may be overwhelmed with existing evaluations so that they may not be able to complete the number of evaluations expected by the plan. Therefore, the reserve pool of evaluators may be used to support the primary evaluators in certain situations. If there are no primary evaluators who have the capacity to do more evaluation tasks, then the reserve pool evaluators may be used to keep the quality plan on-track.

A quality plan may have a plan frequency attribute which determines the frequency which the quality plan is set for. A quality may be set for a longer interval of time (e.g. global target) and then revised periodically within this longer period of time (e.g. interim targets). Therefore, a global target may be set as well as interim targets. For example, the quality plan may be set on a semiyearly global frequency and then revised on a bi-weekly interim. The targets may be adjusted and updated at each interim period. A plan frequency may be one time. Embodiments of the invention are not limited in this regard, and may include any frequency or period applicable to a quality plan.

A quality plan may include a plurality of identification of agents associated with a plurality of interactions, each identification of agent assigned an interactions count number, and a plurality of filters associated with a plurality of interactions.

As described herein, a quality plan may define any applicable parameters or filters for selecting calls or interactions for evaluation. In the context of a call center, some example of filters for example, may include:

Agents—agents associated with (e.g. participated in) interactions. Agents may be defined by attributes, such as a certain skill, or may be part of a team, etc. Each agent may be associated with an interaction or a plurality of interactions and assigned an interactions number.

Direction—whether the call is inbound (received by the call center) or outbound (initiated by the call center).

Channel—interaction format (e.g. audio, chat, email, the Facebook social media service, etc.).

Call Length—calls (e.g. interactions) having durations greater than or less than a particular length. For example, a filter may extract calls between an agent and a customer lasting no more than 5 minutes.

A plurality of filters may be associated with a plurality of interactions. Filters may be analyzed and then chosen to ensure that the filters when applied to a group of interactions, results in a predetermined number of interactions. Filters may be applied repeatedly to a set of interactions to analyze the number of resultant interactions. In other embodiments, filters may be selected based on evaluators and their criteria. For example, evaluators might belong to a regional department of a call center which does not evaluate a given analytics channel category (e.g. audio) or does not handle outbound direction calls. Therefore, filters may be selected to find interactions which match evaluator criteria of only inbound calls, no audio channels, and geographical location. Below is an example of an interaction entity in Javascript programming language in the JSON format by which the filters may be applied; other formats may be used:

i. Interaction Entity

```
  {
    “interaction_id”:”78346387-9838-k3kj-98jj-3489757889”,
    “tenant_id”:”iuj238h2-kj29-kj23-j23k-iou2o3iu3222”,
    “start_time”:”2020-11-10 12:34:55.668 Z”,
    “end_time”:”2020-11-10 12:38:12.345 Z”,
    “channel”:”PHONE”,//other possible value - EMAIL/CHAT/SMS
    “direction”:”INCOMING”,//other possible values - outgoing
    “customer_id”:”12787248974017124”,
    “ani”:”334 445 9893”,
    “dnis”:”374 875 9832”,
    “agents”:[
      {
        “id”:”98398221-2323-edb0-8732-372372871972”,
        “skill”:”TERM_INSURANCE”.
        “team_id”: “65267126-0923-kj22-2652-
983kjnbv38382”
      },
      {
        “id”:”11e70afb-172e-edb0-b9f3-0242ac110002”,
        “skill”:”ACCOUNTING”,
        “team_id”: “65267126-0923-kj22-2652-
983kjnbv38382”
      }
    ],
    “recordings”:[
      {
        “id”:”09d58205-9333-4f76-ad8f-2628a6707c0a”,
        “type”:”audio”,
        “start_time”:”2020-11-10 12:34:55.668 Z”,
        “end_time”:”2020-11-10 12:35:52.268 Z”,
        “media_location” :
“ftp://recorded_media_files/2394823098423/part1.mp4”
      }
    ]
  }
```

In the above example interaction entity, it can be seen that filters may match specific key-value pairs to refine searches for interactions. For example, in the case that a quality plan had evaluators that specialized in term insurance, a filter may be applied to the skill attribute of agents querying for ‘TERM_INSURANCE”.

Embodiments of the invention may enable defining various quotas. For example, a quality plan may have a quota defining the number of evaluation tasks related to a specific evaluator or plurality of evaluators that need to be evaluated or distributed per day, month or other time period (e.g. plan frequency). A quota may be related to a quality manager, e.g., the number of evaluations a specific evaluator is to perform per day or other time period. An example quota may be based on how many evaluators and the number of interactions which need to be evaluated or distributed by the quality plan. The quota may be the expected number of evaluation tasks which needs to be evaluated or distributed by the quality plan. The number of interactions to be distributed per agent may be determined.

As described herein, an effective quality plan may be measured, for example, by metrics such as:

1. Interaction Distribution Rate—The measure of the number of interactions distributed over time. A quality plan should ideally keep distributing interactions matching the set criteria (e.g. quality plan quota) evenly throughout the plan period, the defined time duration of the quality plan.

2. Evaluation Rate—The measure of the number of evaluations completed by evaluators over time. In order to meet or evaluate the expected number of evaluation tasks (e.g. quality plan quota), the evaluators chosen on the plan should complete evaluations regularly in a reasonable amount of time.

Other metrics, and other numbers of metrics, may be used. When a quality plan does not meet (e.g. have parameters that meet or exceed) either of the two metrics, the quality plan has failed in achieving its target. Even if one of metrics is met, the quality plan may still fail in achieving its target. For example, a quality plan may not meet its target interaction distribution rate if the filters chosen for the quality plan do not filter a sufficient number of interactions. For example, filters which do not match an evaluator's criteria (e.g. the quality plan might have a group of evaluators which belong to a department which can never match a given interactions analytics category or a team which never handles outbound calls), may directly result in a shortage of interactions distributed to the evaluators. A quality plan may not meet its target evaluation rate if, for example, the evaluators do not meet their quotas. For example, situations where evaluators may be on leave, where evaluators may be overwhelmed and not be able to complete the evaluation tasks expected, where too few evaluators were chosen relative to the quota, or other situations, may result in evaluators not meeting the expected evaluation rate (e.g. quota).

Embodiments of the invention may enable a preventive mechanism which automatically selects filters based on any number of parameters, indications, rules, thresholds, criteria, settings, configurations, contexts, aspects or any other applicable data or information. The preventive mechanism may be applied to the filters or evaluators selected as part of the quality plan to provide suggestions and warnings to the quality plan manager about the possible issues in the chosen filters or the chosen evaluators at the time of creation of the quality plan and thus avoid the creation of a quality plan with potential possibilities of failures. For example, the preventive mechanism may warn users (e.g. quality plan managers) that the filters chosen as part of the quality plan, when applied to a group of interactions by a process or computer module, result in an insufficient number (e.g. a subset) of interactions. As described herein, the preventive mechanism may examine each filter in the quality plan to identify the most restricting filters by a brute force mechanism. For example, for each filter selected as part of the quality plan, the number of interactions matching the filter may be identified. A filter may be identified as restricting or non-restricting based on the number of interactions which match the filter. For example, if a filter as part of a quality plan matches a minimum of 10 interactions, it may be identified as non-restricting whereas a filter matching only 5 interactions in a quality plan may be identified as restricting. The filters may be identified and sorted in any order (e.g. descending order, most restrictive to least restrictive).

An example preventive mechanism may use past historical data or archived data of quality plans to forecast an evaluation task completion rate or interactions completion rate that the quality plan manager can expect from this quality plan based on the chosen evaluators and their corresponding schedules. As described herein, the preventive mechanism may provide a forecasting mechanism which automatically projects or forecasts a metric of the number of evaluation tasks using historical or archived data of quality plans. Historical data may be past quality plan data that may be logged and saved to a database and statistically calculated for insight. Historical data may, in some embodiments, be evaluation tasks completed without a quality plan or may come from external sources (e.g. documented evaluations written on paper). For example, a quality plan may have historical data pertaining to the total number of evaluations an evaluator has completed in a past plan period. For example, a quality plan may have historical data tallying the number of evaluation tasks completed by an evaluator during a plan period of 6 months. This tally may be saved as a total tally for the past 6 months or a daily tally for each day of the past 6 months. The historical tally data may be used to compute an average forecasted evaluation task completion rate or interactions completion rate to provide a metric to forecast (e.g. future) the number of evaluations for any specified duration. For example, the historical data may be used to compute an average forecasted evaluation task completion rate by dividing the total tally of evaluations completed during a past plan period by the number of days in an adjusted past plan period. Example Formula 1 describes an example average forecasted evaluation task completion rate:

Average Forecasted Evaluation Task Completion Rate=Historical Total Completed Evaluations/Adjusted Plan Period Formula 1

The average forecasted evaluation task completion rate may be computed as the total tally of the number of evaluation tasks completed during a plan period divided by the adjusted plan period. The adjusted plan period may be the past plan period accounting for leave or vacation days during the past plan period, subtracting these days from the past plan period; units for a plan period may be days, or another unit of time. For example, an evaluator may have his/her average forecasted evaluation task completion rate calculated from his/her historical evaluation task completion data from a quality plan with a 6 month plan period (e.g. 180 days). To simplify the example, it is assumed that an evaluator has an example historical task total of 346 evaluation tasks during the plan period and only worked during the workdays (e.g. excluding 52 Saturdays and Sundays in 180 days) and took vacation for 5 workdays during the plan period. Therefore, the adjusted plan period may be calculated as follows: 180 total days−52 leave days−5 vacation days=123 days in the adjusted plan period. The average forecasted evaluation task completion rate is therefore, 346 evaluations/123 days=2 evaluations/day. The average forecasted evaluation task completion rate may then be used as a metric to forecast the number of evaluation tasks for an evaluator for any specified duration by multiplying, described herein.

In other embodiments, the historical evaluation data may be received as a daily tally (e.g. Evaluations/Day) for each day in the historical plan period and an average forecasted evaluation task completion rate may be computed by summing the daily tally of all days in the plan period and dividing by the adjusted plan period as in example Formula 2:

Average Forecasted Evaluation Task Completion Rate=(ΣHistorical Completed Evaluations Per Day)/Adjusted Plan Period Formula 2

For example, assume an evaluator has historical evaluation data wherein the evaluator is part of a past plan period of 3 days which occurs during a workweek (e.g. Monday, Tuesday, and Wednesday) and that no leave or vacations were taken (e.g. the adjusted plan period is the plan period). If leave or vacation days were taken, the period of time of the leave or vacation days may be ignored. For example, only active work days are calculated towards the average forecasted evaluation task completion rate. Assume the evaluator completes 3 evaluations on Monday, 4 evaluations on Tuesday, and 2 evaluations on Wednesday. Therefore, the forecasted evaluation task completion rate according to Formula 2 may be calculated as (3 evaluations+4 evaluations+2 evaluations)/3 days=3 evaluations/day. If in the example, the evaluator takes leave on Thursday and Friday, the average forecasted evaluation task completion rate may remain unchanged, as the leave or vacation days are not calculated into the average. The average forecasted evaluation task completion rate may then be used as a metric to forecast the number of evaluations for an evaluator for any future specified duration by multiplying, described herein. The averages may be calculated for any time period, and need not be limited to any specific time period (e.g. bi-weekly, half-day, monthly, etc.). The tallies may also be taken for any time duration, and need not be limited to any specific time duration. Formula 2 provides an example for a daily time duration, but may be modified for any specific time duration.

The average forecasted evaluation task completion rate may then be used to forecast the total number of evaluation tasks for an evaluator for a future quality plan period. The forecasted total number of evaluation tasks may be multiplied according to an evaluator's future schedule. For example, the average forecasted evaluation task rate may be multiplied by the number of future evaluation days in the plan period. The number of future evaluation days may be adjusted by subtracting, from the number of evaluation days (in the plan period), the future leave and time-off schedules of evaluators. Therefore, the total forecasted number of evaluations may reflect an evaluator's personal schedule and circumstances. For example, an evaluator may participate in a quality plan which is on a monthly (e.g. 30-days) frequency, and may include in his/her future five day workweek schedule, a vacation day every Tuesday of this monthly plan period (e.g. four Tuesdays in a typical month). Assuming this evaluator has an average forecasted evaluation task completion rate of three interactions/day calculated by the historical data of this evaluator in the past quality plans, by Formula 1 or Formula 2, as described. This evaluator may be forecasted to complete 48 total interactions during this monthly plan period (e.g. 3 interactions/day*(30 total days−10 leave days (e.g. weekends)−4 vacation days (e.g. Tuesdays)=16 evaluation days)). The total forecasted number of evaluation tasks reflects the total number of evaluation tasks an evaluator may be forecasted to complete during a quality plan period accounting for the evaluator's personal schedule and circumstances.

As described herein, embodiments of the invention may improve evaluation distribution technology to provide a proactive, on-the-fly correcting mechanism. During the execution or runtime of the quality plan, unknown issues may arise that require proactive correction of the quality plan. For example, some examples of unknown and unforeseen issues may be that an evaluator goes on unplanned leave, an evaluator may be busy in certain escalations and could not complete his/her work, or an evaluator may have a lower work performance than expected (e.g. evaluator's actual evaluation task or interactions completion rate trails the expected number of evaluations). The proactive correcting mechanism may address these issues by automatically correcting these issues at runtime by periodically checking metrics and taking proactive action. In some embodiments, an off-track % may be computed to provide a benchmark for the quality plan to take proactive corrective action. For example, an off-track % may be computed as the % difference or shortfall between the number of expected evaluations (e.g. quota) to the number of actual evaluation tasks or interactions completed in the quality plan. Proactive action may be triggered based on a predetermined threshold of acceptable off-track % (e.g. a 5% shortfall between the number of expected and number of actual evaluation tasks completed (interactions)). As described herein, a proactive action may include reassigning evaluations of underperforming evaluators to evaluators who have completed their evaluations up until a point in time of the plan period. A proactive action may include reassigning evaluations to a reserve pool of evaluators.

While examples herein concern agents at a call center, the application of this invention is generic and shall be applicable to any domain/industry.

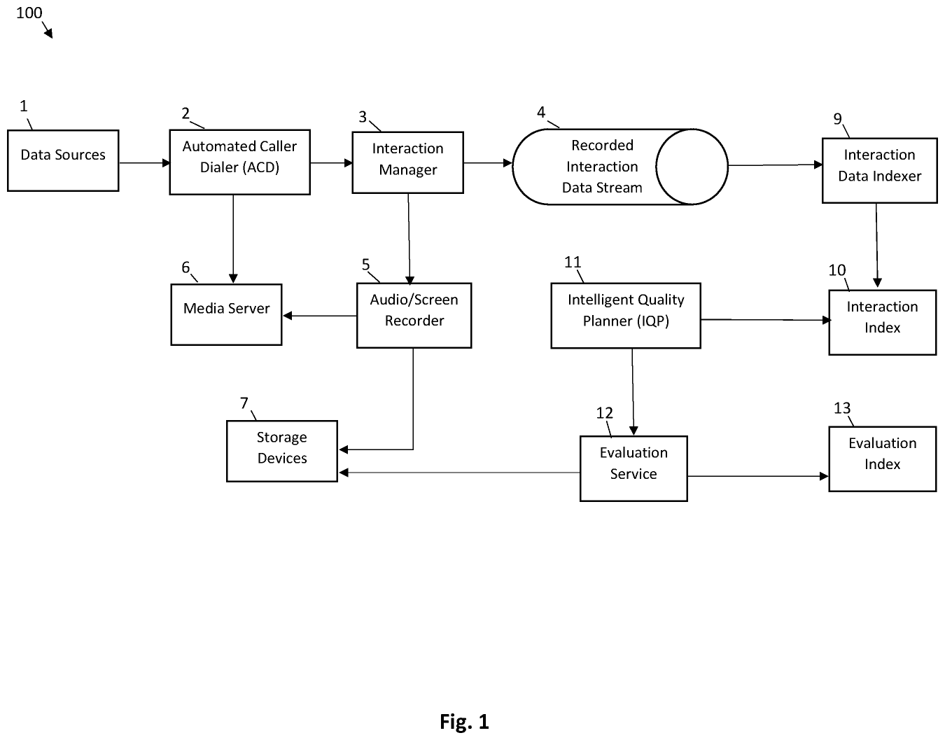

Reference is now made to FIG. 1, which is a block diagram of an exemplary system 100 according to embodiments of the present invention. It should be understood to a person skilled in the art that the architecture of the exemplary system described herein does not limit the scope of the invention and embodiments of the invention may be implemented in other systems. System 100 depicts a high level architecture diagram of the main components of a contact center with a quality management system with an automated quality planning solution. System 100 may include data sources 1 (e.g. voice recordings, screen recordings, video recordings, emails, and chat transcripts and attachments, etc.). In the context of a call center, these may be recorded interactions or archived communication sessions between an agent and a customer, for example for the agent to assist the customer in planning, installing, troubleshooting, maintenance, upgrading, etc., of a product or service. It should be understood to a person skilled in the art that data sources 1 are exemplary data sources and any other data source that may provide data related to interactions or data of interactions with customers or clients may be considered as data sources 1.

Automated Caller Dialer (ACD) 2 may be configured to receive and accept data from data sources 1 (e.g. incoming calls or interactions) and route the data to live agents. ACD 2 may facilitate outbound calls from agents to the customers automatically and may dial customer telephone numbers, and deliver important information through an automated message, or can connect a customer to a live agent once the call has been answered. For example, ACD 2 may facilitate incoming calls to a call center and route the call to the correct department based on a customer's menu selection in an automated phone system (e.g. customers wishing to speak to a live agent from the billing department may use a keypad to press ‘3’ in response to an ACD voice prompt “for billing department press 3”). ACD 2 may be configured to provide computer telephony event information. Computer telephony event information describes events in a call center and may include connects, holds, transfers, disconnects, etc. These computer telephony events may signal the beginning of an action for an interaction, for example, upon a connect event, it may trigger a recording process for the interaction. Accordingly, the recording process may end upon a disconnect event.

Interaction manager 3 may be operatively coupled to ACD 2 and may include any data, information, logic and/or applications required in order to locate, retrieve, manage or otherwise manipulate data or information in ACD 2. For example, interaction manager 3 may maintain or store metadata as known in the art. As known in the art, metadata may enable searching for information objects associated with the metadata by inspecting their related metadata. For example, metadata associated with a recording of a call may indicate when the call was held, the agent who handled the call, an outcome of the call etc.

It will be understood by those skilled in the art that any applicable data, parameters or other information may be stored as metadata or other type of data and utilized by interaction manager 3 or other components of system 100. For example, during a progress of a call, or upon termination of a call, various parameters may be recorded, e.g., agent identification, call duration, call outcome etc. Such parameters or other parameters may be obtained automatically by various systems or applications or may be obtained otherwise, e.g., by having the agent log various aspects of the call, for example, the outcome of the call, e.g., a product was sold. Any applicable information thus or otherwise obtained may be maintained by interaction manager 3 and may further be used, for example, in order to select calls or interactions for evaluation as described herein.

Interaction manager 3 may coordinate operations involving other components or units in system 100. Interaction manager 3 may coordinate the recording flow according to the computer telephony events received from ACD 2. Upon receiving an event from ACD 2 for an eligible recording event, interaction manager 3 may generate interaction metadata packets and send the metadata packets to the recorded interaction data stream 4. Recorded interaction data stream 4 may send or stream the metadata packets to an indexer to be organized. Interaction manager 3 may simultaneously send the corresponding interaction data to audio/screen recorder 5 to be recorded and stored. For example, interaction manager 3 may receive from ACD 2 an eligible computer telephony “connect” event signaling the beginning of an interaction between an agent and a customer and thus may initiate the recording process. Interaction manager 3 may then send generated metadata packets containing details about the call (e.g. agent name, product sold) to recorded interaction data stream 4 to be indexed and simultaneously record and store the interaction by initializing audio/screen recorder 5 to capture the interactions data. This process, for example, may be stopped once a computer telephony disconnect event is received from ACD 2.

It will be understood by those skilled in the art that audio/screen recorder 5 may be any application, device, apparatus, or other means which is utilized to record captured interaction data from interaction manager 3. For example, audio/screen recorder 5 may upload the interaction data to storage devices 7. Storage devices 7 may be any database/repository or a scalable distributed storage device (e.g. file storage services). Audio/screen recorder 5 may simultaneously or correspondingly send the interactions data to media server 6 to be streamed, for example, in real-time for live streaming of the interaction to be listened or viewed. For example, audio/screen recorder 5 may send data packets over session initiated protocol (SIP) and may actively be streamed and viewed/listened in a web browser (e.g. Web Real-Time Communication protocols).

Interaction data indexer 9 may be responsible for indexing the generated metadata in recorded interaction data stream 4. Indexing, as known in the art, may be to define, arrange, separate, classify, grade, rank, sort, etc., to an organized (e.g. compliant) format. Interactions data indexer 9 may be any service or device for indexing and may be connected to interaction index 10 which may be a database to store the organized interactions metadata. For example, interactions data indexer 9 may sort interactions metadata by applicable parameters or filters (e.g. channel, direction, etc.) and store to interaction index 10 for fast query and retrieval. Interactions data indexer 9 may organize or sort interactions metadata according to the significance of each applicable parameter or filter. For example, interactions data indexer 9 may prioritize sorting interactions metadata by call location if it is known that evaluators will frequently search for interactions by call location.

Intelligent quality planner (IQP) 11 may be a logical collection of sub application services according to embodiments of the invention. IQP 11 may be responsible for the creation and management of quality plans, the sampling of interactions from a database (e.g. from interactions index 10), may include a preventive mechanism, and may include a forecasting mechanism. For example, IQP 11 may facilitate a quality plan by fetching interactions from interaction index 10 and may correspondingly fetch evaluations data for evaluators from an evaluation index 13. IQP 11 may communicate with evaluation service 12 to start the evaluation of an interaction sampled by IQP 11. Evaluation service 12 may be an inter-dependent service with IQP 11 responsible for the initiation and management of evaluation workflows. For example, evaluation service 12 may store details of an evaluation like the answers, scores, and evaluator details, etc., and stores such data to evaluation index 13 to be later retrieved by IQP 11. Evaluation service 12 may fetch from storage devices 7 the corresponding recording of a sampled interaction to be played back so that the evaluator may evaluate it. IQP 11 may then analyze and calculate, using the preventive and forecasting mechanisms, an on-track quality plan based on the data stored by interaction index 10 and evaluation index 13, described herein. IQP 11 may then execute the on-track quality plan by communicating to evaluation service 12 to assign interactions to evaluators.

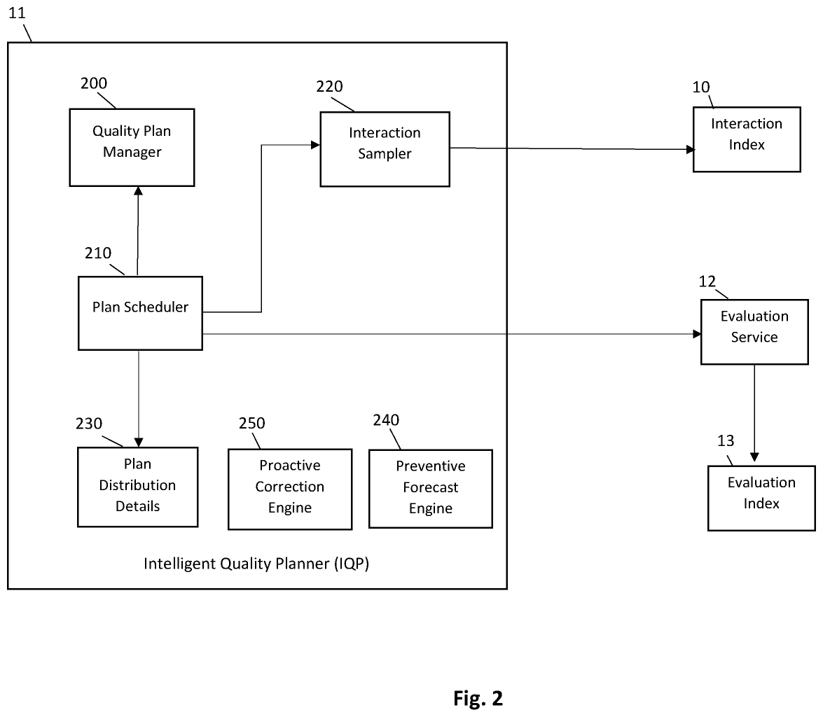

Reference is now made to FIG. 2 which is an exemplary block diagram of the intelligent quality planner 11 according to embodiments of the invention. Quality plan manager 200 may be responsible for outlining the quality plan and may define any applicable parameters or filters for selecting interactions for evaluation. The quality plan manager 200 may include configurable parameters which may, for example, specify the number of expected evaluations (quota), the plan frequency, the list of evaluators in the quality plan, the agents to be evaluated on the quality plan etc. The quality plan manager 200 may include a graphical user interface (GUI) to display the configurable parameters and modify such parameters. The GUI may include windows, icons, buttons, menus, etc., to carry out commands to display, activate, update, etc., embodiments of the invention. The parameters from quality plan manager 200 may be fetched by plan scheduler 210 to activate the quality plan on a scheduled or periodic basis. As shown by interaction sampler 220, the interaction sampler may retrieve the interactions metadata for each interaction sampled for the quality plan from interaction index 10 (of FIG. 1). Interaction sampler 220 may filter the interactions metadata to find a number of interactions, for example, interaction sampler 220 may repeatedly apply sets of filters from the quality plan (e.g. fetched from quality plan manager 200) to the interactions metadata retrieved from interaction index 10. Applying the filters to the interactions metadata may result in a subset of interactions which match the filters. The number of resultant interactions (e.g. how many interactions in the subset) may be used to determine whether or not the filters need to be adjusted. The filters may be determined to be restrictive (e.g. such determination performed automatically by a computer as described herein), if the application or set of filters used results in a set of interactions which does not meet a predetermined threshold. For example, if a quality plan has a quota of 25 interactions and the sets of filters applied by interaction sampler 220 to interaction index 10 results in only 10 interactions, the preventive forecast engine 240 may remedy the issue by identifying the restrictive filters and alerting the quality plan manager 200. The quality plan manager 200 may continually adjust the filters (e.g. removing or adding filters) until the number of interactions meets a predetermined threshold, which may, in some embodiments, be the quota.

The plan scheduler 220 is responsible for and activates the quality plan and may continuously fetch and distribute the interactions to evaluators (e.g. transmit data describing interactions to evaluators using computer systems described herein, or other systems). Plan scheduler 210 may retrieve the quality plan parameters from quality plan manager 200 and query interaction sampler 220 to find a predetermined number of interactions stored for example in interaction index 10. Plan scheduler 210 may be executed periodically and may check if there is a need to distribute interactions to evaluators based on the current distributed interactions on the quality plan so far and the interactions count number target (e.g. quota) that needs to be achieved. For example, if a quality plan has a quota or interactions count number of 25 interactions and the current number of distributed interactions on the plan is only 20, plan scheduler 210 may retrieve 5 additional interactions using the interaction sampler 220 to meet the quota. Plan scheduler 210 may retrieve from quality plan manager 200, a list of agents, associated with their identification, which need to be evaluated and evenly distribute the agent's corresponding interactions over a period of time, ensuring an agent's interactions are distributed evenly to the evaluators. For example, a yearly time period may be segmented by months, distribution of interactions may be spread evenly over each of the months. An example of a quality plan which distributes to evaluators 5 interactions per agent for 5 agents in a monthly (4-week) plan period is shown in Table 1:

TABLE 1

| | Interaction Distribution Over Time | | | | |
|---|---|---|---|---|---|
| Week/Agent | Agent 1 | Agent 2 | Agent 3 | Agent 4 | Agent 5 |
| Week 1 | 2 | 2 | 2 | 2 | 2 |
| Week 2 | 1 | 1 | 1 | 1 | 1 |
| Week 3 | 1 | 1 | 1 | 1 | 1 |
| Week 4 | 1 | 1 | 1 | 1 | 1 |

Here, 5 interactions belonging to an agent are retrieved for a month and are distributed weekly to an evaluator. As interactions are spread evenly through a monthly plan, each agent may have his/her interaction distributed and assigned to an evaluator once a week. However, 1 interaction a week (4 interactions a month) will not meet the required number of 5 interactions a month, therefore, the unassigned interaction for an agent may be cycled and distributed to the first week. By assigning the unassigned interactions to the beginning of the plan period, this may ensure that evaluators have enough time to complete all the evaluations.

Another example of a quality plan which has 5 agents and is required to distribute 40 interactions per agent in a monthly plan is shown in Table 2:

TABLE 2

| | Interaction Distribution Over Days of a Week | | | | |
|---|---|---|---|---|---|
| Day/Agent | Agent 1 | Agent 2 | Agent 3 | Agent 4 | Agent 5 |
| Day 1 | 3 | 3 | 3 | 3 | 3 |
| Day 2 | 2 | 2 | 2 | 2 | 2 |
| Day 3 | 1 | 1 | 1 | 1 | 1 |
| Day 4 | 1 | 1 | 1 | 1 | 1 |
| Day 5 | 1 | 1 | 1 | 1 | 1 |
| Day 6 | 1 | 1 | 1 | 1 | 1 |
| Day 7 | 1 | 1 | 1 | 1 | 1 |

In Table 2, the evaluators are distributed 10 interactions per week for a total of 40 interactions a month (4 weeks) for each agent. For larger numbers of interactions to be distributed, it may be further granulated to assigning interactions by day. Table 2 shows 10 interactions per week, assigning 1 interaction per day for 7 days leaves 3 interactions unassigned. The unassigned evaluations may be distributed from the beginning of each week (Day 1, Day 2 . . . ) or may be distributed in a left-skew fashion which prioritizes the beginning of each separation period. For example, if the distribution is segmented by day, the distribution may prioritize the first few days as shown in Table 2. If, for example, the distribution is segmented by weeks, then a process may prioritize the first few weeks (Week 1, Week 2 . . . ) as in Table 1.

Plan scheduler 210 may keep track of the distributions by sending the distribution details to the plan distribution details 230. Plan distribution detail 230 may include identifying information, for example, the agent ID, evaluator ID, interaction ID, and the date of distribution. The plan distribution details may keep track of information pertinent to the distribution of interaction. For example, an interaction may have been handled by a specific agent, associated with their agent identification, and may have been distributed to an evaluator on a certain date. Below is an example of an example Javascript language representation (e.g. JSON) of a plan distribution detail entity:

Plan Distribution Detail Entity:

```
{
  “planId” : 334982348230,
  “distributionDetails” : [
    {
      “agent_id”:49729348234,
      “evaluator_id” : 9083402938,
      “interaction_id” : 382304823084,
      “distributionDate” : 2021-01-18
    },
    {
      “agent_id”:49853493434,
      “evaluator_id” : 9834283922,
      “interaction_id” : 233090930233,
      “distributionDate” : 2021-01-19
    },
    {
      “agent_id”:0093903233,
      “evaluator_id” : 9083402938,
      “interaction_id” : 26511265652,
      “distributionDate” : 2021-01-18
    }
  ]
}
```

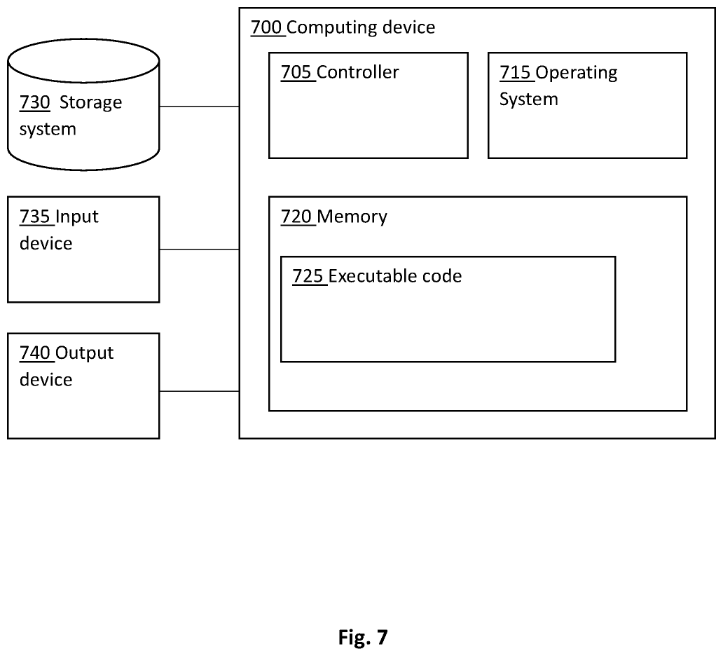

Plan scheduler 210 may then activate the evaluation process by sending the information to the evaluation service 12 for the evaluation to be carried out. Evaluation service 12 receives the distribution details (e.g. which interaction goes to which evaluator, during what time) and assign the interactions to the evaluators as scheduled. Assigning, distributing or reassigning, interactions from an evaluator to another evaluator may include removing the interactions from the evaluator's task list and transmitting, e.g. via Plan Scheduler 210, from a computing device 700 (of FIG. 7) to the other evaluator, data describing or including the interaction(s), and/or maintaining a database at evaluation index 13 a recording of which evaluators are assigned which interactions.

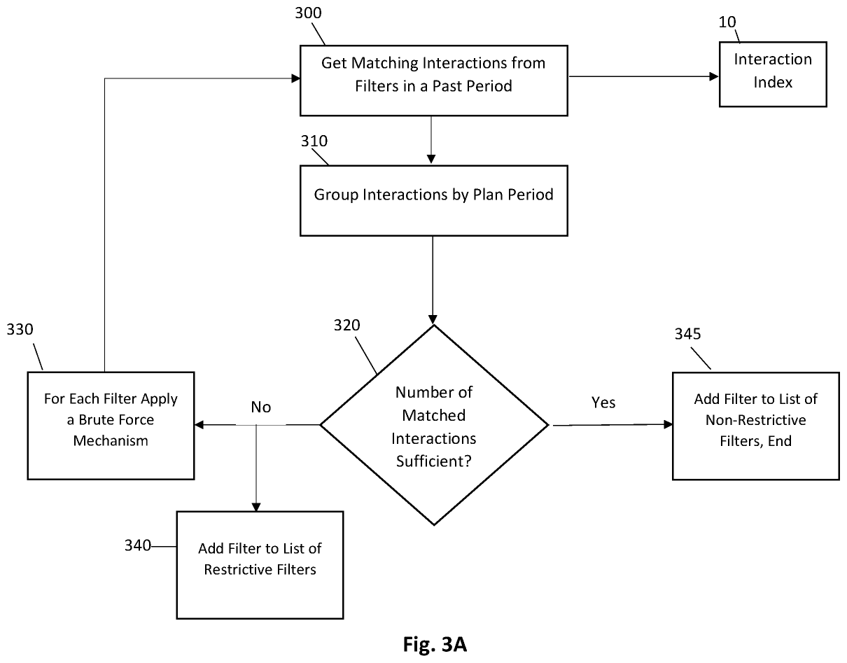

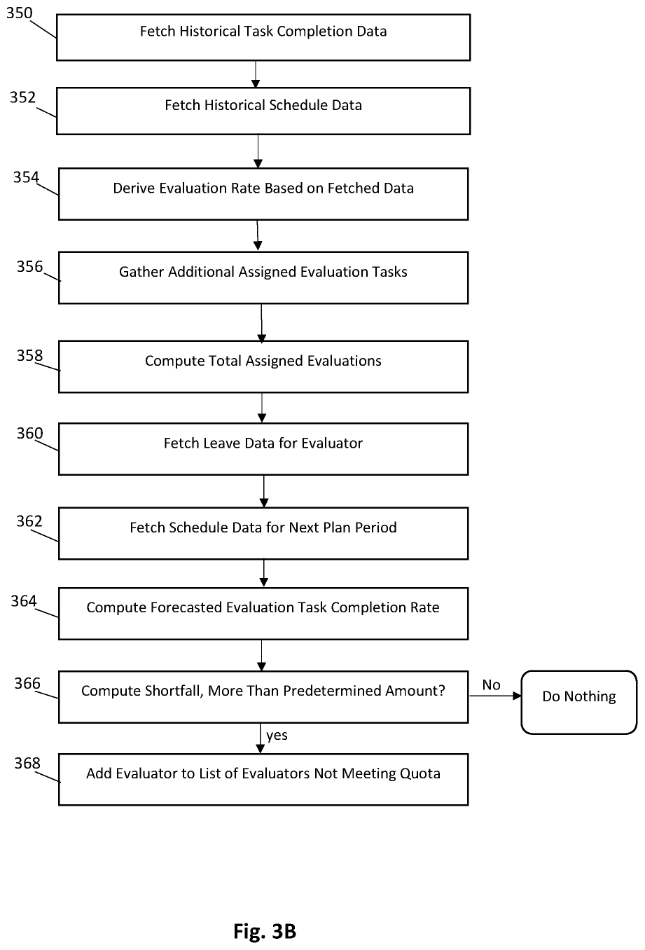

IQP 11 may include a preventive forecast engine 240. Preventive forecast engine 240 may communicate with quality plan manager 200 to facilitate quality plan schedules which meet the target quota. Preventive forecast engine 240 may run or be executed before the execution of a quality plan and warn quality plan manager 200 of any issues or shortfalls of the quality plan, described herein. Searching (e.g. querying) for interactions may be facilitated by interaction sampler 220 through the use of filters. To meet target quotas, in one embodiment filters should not restrict the number of interactions which result from the query of the filters in the quality plan. Therefore, a search filter analysis algorithm is described to correct restrictive filters in one embodiment. Reference is now made to FIG. 3A showing an algorithm flow diagram of the search filter analysis algorithm as part of the preventive forecast engine 240. At operation 300, a query is run or executed on the interactions sampler 220 to find from interaction index 10 the number of resultant interactions in a past period by applying the filters prescribed by quality plan manager 200. For example, the interactions sampler 220 may apply the filters and sample the interactions from the last 3 months. At operation 310, interactions which match the filters (e.g. which have characteristics meeting filter requirements or rules) may then be grouped by a time period, which in one embodiment is the plan period. For example, the resultant interactions after applying the filters from the past three months may be grouped by the plan period. For simplicity, in the example, the quality plan period is assumed to be one month. Said differently, the number of resultant interactions during a past period may be averaged by the quality plan period. For example, if a quality plan is on a monthly basis and if the filters applied to find the number of interactions in the last three months results in 48 total interactions, the resultant interactions may be grouped by the quality plan period (monthly), for example, three months. Therefore, an average of 16 interactions/month for the past 3 months (48 interactions/3 months=16 interactions/month). At operation 320, the number of matched interactions (averaged by the quality plan period) by the filters is checked against the quota of the quality plan. For example, a quality plan may have a quota of 20 interactions/month and the applied filters only result in 16 interactions/month. If the number of interactions is sufficient (e.g. more than or equal to the quota), then the process stops and the filters are added to a list of non-restrictive “green” filters. However, if the number of filtered or matched interactions by the filters is insufficient (e.g. less than the quota), at operation 330, a brute force mechanism may be employed on the set of filters to find a set of green filters which match or exceed the number of expected interactions (e.g. quota) and identify the filters which restrict the number of filtered interactions which may result from the query. At operation 330, for each filter in the quality plan, a brute force mechanism is employed to check the selected filter against a set of filters. For example, a first filter (e.g. call direction) may be added as a search filter and operations 300-320 may be repeated. If the addition or application of the “call direction” filter returns a filtered number of interactions greater than or equal to the quota, then this filter is added to a list of green filters in operation 345. If not, this filter may be added to a list of restrictive filters and may be displayed to the quality manager to warn that the filter is restrictive in operation 340. This may be done for every filter in the search filter set. At operation 340, the warning of restrictive filters may be displayed to the quality plan manager 200.

It may be helpful in some embodiments of the invention to ensure or predict that the chosen evaluators on the quality plan are able to evaluate their assigned interactions. Preventive forecast engine 240 may include an evaluator performance forecast to determine if the evaluators which are assigned to the quality plan can meet their target quotas. Reference is now made to FIG. 3B showing an algorithm flow of the evaluator performance forecast algorithm. At operation 350, historical evaluation task completion data is fetched from the interaction index 10. For example, historical evaluation task completion data, such as the number of filtered interactions evaluated during a past historical quality plan period may be retrieved by evaluation service 12. At operation 352, historical schedule data may be fetched for each evaluator in the quality plan to know during which time the evaluators worked or their shifts, noting the leave and vacation periods. At operation 354, an evaluation rate may be determined by averaging, for example, the historical evaluation task completion per day accounting for historical schedule data. For example, in a monthly plan period, an evaluator may have had a historical evaluation task completion rate of 150 total evaluations averaging 5 evaluations for a month (30 days). However, accounting for historical schedule data, for example, assume that the evaluator did not work every Tuesday of the month, the historical evaluation average may be recalculated to be 5.77 evaluations per day (150 total evaluations/(30 days−4 days leave)=5.77 evaluations/day). Therefore, this provides a more accurate estimate of the number of actual completed evaluation tasks of the evaluator and provides an improved forecast. At operation 356, additional assigned evaluation tasks are gathered. Preventive forecast engine 240 may iterate on all active quality plans of this evaluator and tally the number of evaluation tasks assigned to the same evaluator by the other quality plans. The additional evaluation tasks from other quality plans may be the measure of the ‘true’ workload of the evaluator, the total amount of evaluation tasks the evaluator is currently responsible for. At operation 358, the total assigned evaluations from all quality plans may be tallied and totaled. At operation 360, the leave data (e.g. when an evaluator plans to not be at work, or on vacation, etc.) as well as schedule data (e.g. when an evaluator is working in which shift) for the evaluator for the next plan period in operation 362 may be fetched. For example, an evaluator may have certain working hours and a vacation (e.g. leave) scheduled for the next plan period that may be accounted for. At operation 364, a forecasted evaluation task completion rate is calculated based on the historical average evaluation task completion rate considering the vacation and leave periods scheduled. For example, continuing the above example, the evaluator has a historical evaluation rate averaging 5.77 evaluations a day. Therefore, to obtain the forecasted evaluation task completion rate, this average may be multiplied to future time periods accounting for scheduling and vacation or leave data obtained in operations 360 and 362. For example, assume the evaluator in the next plan period is not working for an entire week (30 days−7 days=21 days). The forecasted number of evaluation tasks completion rate may therefore be multiplied to each working day and calculated to be (5.77 evaluations/day*21 days=121.17 forecasted evaluations). Therefore, this evaluator is expected to complete 121.17 evaluations during the next plan period. At operation 366, the number of forecasted evaluations may be checked against the quota in the quality plan. A difference or shortfall may be computed by subtracting the quota by the number of forecasted evaluations. If the shortfall is more than a predetermined amount (e.g. more than 5%), the evaluator may be added to a list of evaluators not meeting the target quota and a warning displayed to the quality manager (e.g. 200 in FIG. 2) in step 368. If the shortfall is less than or equal to the predetermined amount, then no action is taken.

Preventive forecast engine 240 may be called or executed for each quality plan and may be for example in the form of an application programming interface (API). For example, IQP 11 may include preventive forecast engine as an API included in the quality plan manager 200 which executes before the activation of the quality plan ensuring the search filters are not restrictive as well as ensuring evaluators on the quality plan will meet the quality plan quota. The quality plan manager 200 may utilize the GUI of a software module which embeds the API allowing the quality plan manager to view warnings and modify parameters of the quality plan before the activation of the quality plan.

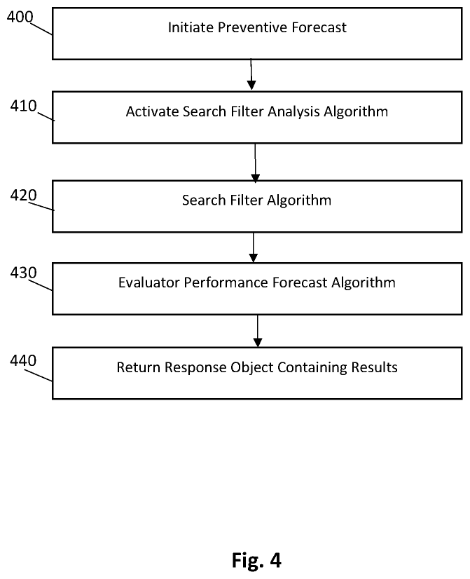

Shown in FIG. 4 is high level data flow of an example preventive forecast engine, according to some embodiment. As shown, at operation 400, quality plan manager 200 may initiate a preventive forecast by calling upon a quality plan manager service. The quality plan manager service may be an active service that continually updates and is run periodically. This service may facilitate the plan scheduler 210 to retrieve necessary parameters from quality plan manager 200 and retrieve interactions from interactions sampler 230. At operation 410, the quality plan manager service activates the search filter analysis algorithm. At operation 420, the search filter analysis algorithm searches the interactions metadata in interactions index 10 for matching interactions and notes the restrictive filters (e.g., the example algorithm of FIG. 3A). At operation 430, the evaluator performance forecast algorithm searches the historical evaluation task completion rate in evaluation index 12 and forecasts an expected evaluation task completion (algorithm of FIG. 3B). The evaluator performance forecast algorithm may be done simultaneously or independent of the search filter analysis algorithm. After both, or one of the preventive algorithms run, at operation 440, a preventive response object containing the information may be returned to the quality plan manager to be viewed and acted upon. Below is an example Javascript programming language preventive analytics response object in the JSON format:

Sample Preventive Analytics Response Object:

```
    {
      “searchFilterAnalysis”:{
        “requiredNumberOfInteractionsPerAgent”:5,
        “agentsWithInsufficientInteractionsWithoutFilters” :[
12387123718, 23094230482 ],
        “greenFilters” : [“CHANNEL” , “DIRECTION” ],
        “restrictiveFilters” : [
          {
            “filter”: “CALL_LENGTH”,
            “avgInteractionsPerAgent”:[
              {
                “agent_id”: 98748973474,
  “matchedInteractionsWithGreenFilters” : 2,
  “matchedInteractionsWithAllFilters” : 1
              },
              {
                “agent_id”: 29484982344,
  “matchedInteractionsWithGreenFilters” : 3,
  “matchedInteractionssWithAllFilters” : 1
              }
            ]
          }
        ]
      },
      “evaluatorAnalysis”:{
        “expectedEvaluationPerEvaluator”: 50,
        “totalEvaluatorsInPlan”: 4,
        “potentialEvaluatorsNotMeetingTarget”: [72637623672,
34244542542],
        “totalForecastedEvaluationCount”: 188,
        “deficitWithTarget”: 12,
        “historicalAverages”:[
          {
            “evaluator_id”:72637623672,
            “avgEvaluationsHistorical”: 45,
            “leaveAdjustedForecast” : 41,
            “numberOfDaysLeave” : 2
          },
          {
            “evaluator_id”:34244542542,
            “avgEvaluationsHistorical”: 47,
            “leaveAdjustedForecast” : 47,
            “numberOfDaysLeave” : 0
          },
          {
            “evaluator_id”:12983874874,
            “avgEvaluationsHistorical”: 52,
            “leaveAdjustedForecast” : 52,
            “numberOfDaysLeave” : 0
          },
          {
            “evaluator_id”:6524176345,
            “avgEvaluationsHistorical”: 50,
            “leaveAdjustedForecast” : 50,
            “numberOfDaysLeave” : 0
          }
        ]
      }
    }
```

The quality plan manager may be able to view this object and act accordingly. For example, it may be displayed (e.g. GUI) to the user (e.g. quality plan manager) in a tabular format as shown in the example below:

Preventive Analytics Results

| | | | |
|---|---|---|---|
| Search Filter Analysis | | | |
| Following Agent don't | Agent 3, | | |
| have enough interactions | Agent 5 | | |
| in the recent past | | | |
| Green | Channel, | | |
| Filters | Direction | | |
| Filter which don't | | | |
| match enough Interactions | | | |
| Filter Name | Agent | Matched | Matched |
| | | Interactions | Interactions |
| | | with Green | with All |
| | | Filter | Filter |
| CALL LENGTH | Agent 2 | 3 | 1 |
| No of Holds | Agent 5 | 4 | 2 |
| Evaluator Performance | | | |
| Analysis | | | |
| Forecasted Evaluations | 188 | | |
| Expected Evalutions | 200 | | |
| ShortFall | 12 | | |
| Potential Evaluators | Evaluator 1, | | |
| Not meeting target | Evalutor 4 | | |
| Alternative Evaluators with | Evaluator 6, | | |
| better Evaluation | Evaluator 7 | | |
| Completion Rate | | | |

IQP 11 may include a proactive correction engine 250. Proactive correction engine 250 may run or be executed periodically and may reassign the interactions to evaluators who have completed their work or to a reserve pool of evaluators to increase the probability of meeting the quality plan quota. Reassigning may include removing an interaction from the responsibility of a certain evaluator (e.g. removing from a list of interactions associated with the evaluator), assigning to a different evaluator (e.g. adding to that evaluator's list) and transmitting the interaction's data to the new evaluator. The proactive correction engine 250 may run for all quality plans or a subset of quality plans to ensure each quality plan is on an on-track course. To facilitate proactive correction, quality plans that participate in proactive correction may specify a predetermined threshold value or tolerance of evaluators not meeting their quotas, e.g. an off-track threshold %. This may be a setting configured by the quality manager while creating the quality plan and may be a measure of leniency in the adherence to evaluation schedule which is acceptable for the user and is configurable and should typically be set to less than or equal to 5% to have a good quality adherence process. This number may be expressed as a %, for example, a quality plan may set with an off-track % of 5% and therefore a tolerance of 5% should be surpassed before any proactive correction actions are taken.

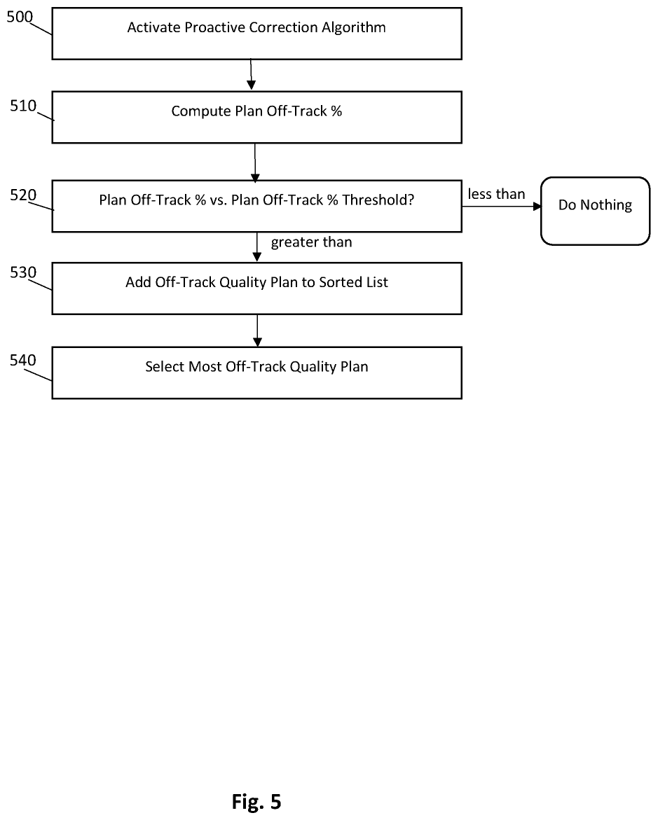

The quality plans participating in proactive correction may also specify a list of a reserve pool of evaluators to serve as supplementary evaluators if and when the primary evaluators are exhausted (e.g. the primary evaluators list is spent or empty). Referring now to FIG. 5, a proactive correction engine 250's example algorithm is described. At operation 500, the proactive correction algorithm is activated or executed and the number of expected evaluation tasks (e.g. quota) for each quality plan is retrieved. At operation 510, the proactive correction algorithm may compute the plan off-track % by comparing the expected number of evaluation tasks (e.g. quota) to the number of actual completed evaluation tasks for a proactive correction period. The number of actual evaluation tasks completed during the plan period may be the number of evaluation tasks completed since the beginning of the plan period or since the beginning of the proactive correction period. For example, a quality plan may have a plan period of one month with weekly proactive correction. Therefore, a weekly proactive correction plan may count the number of actual completed evaluation tasks since the beginning and until the end of each week.

As an example, assume a quality plan has a group of evaluators with an expected number (e.g. quota) of 80 evaluations in a month and the proactive correction is done weekly. Given this assumption, then approximately 4 evaluation tasks are expected per work day (−20 work days in one month, thus 80 evaluation tasks/20 work days=4 evaluation tasks/work day). Since there are 5 workdays in a week, then it can be expected that 20 evaluation tasks should be completed by the evaluators in a work week (4 evaluation tasks/work day*5 work days/work week=20 expected evaluation tasks/work week). Further assuming that the proactive correction is in the third week and in the third week, evaluators have historically actually only completed 15 evaluations. The off-track % may therefore be calculated to be 25% off-track ((20 expected evaluations/week−15 actual evaluations/week)/(20 expected evaluations/week)=25% off-track). The plan off-track % may be computed for any period and need not be limited. The example above uses an example proactive correction period of weekly. Shown below is an example Formula 3 to compute off-track %:

Plan off-track %=(Expected Evaluation Tasks Completed Per Period−Actual Evaluation Tasks Completed Per Period)/(Expected Evaluation Tasks Completed Per Period). Formula 3

At operation 520, the off-track % may be compared against an off-track threshold % set by the quality plan manager. For example, an off-track threshold % may be set by the quality plan manager to be 5%, therefore, any plan having an off-track % exceeding 5% or another threshold may be considered off-track; otherwise the plan may be considered on-track. If the off-track % is greater than the off-track threshold %, then the proactive correction engine 250 may add the quality plan to a list of quality plans which are off-track. At operation 530, the filtered quality plans which are off-track are sorted in descending order, wherein the quality plan with the highest off-track % is listed first. At operation 540, the most off-track plan may be selected from the list and for each evaluator that is part of the off-track plan, the following example algorithm may be applied:

1. Compute the off-track % of each evaluator in the quality plan. The off-track % for each evaluator is computed according to the example Formula 4 below:

Evaluator off-track %=(ΣExpected Evaluation Tasks Completed Per Period Per Plan)−(ΣActual Evaluation Tasks Completed Per Period Per Plan)/(ΣExpected Evaluation Tasks Completed Per Period Per Plan) Formula 4

For each evaluator that is part of the off-track plan the evaluator off-track % is computed by summing across each plan the evaluator is a participant in, the expected number of evaluation tasks that the evaluator may be expected to complete. For example, an evaluator X may be a participant in 2 plans, plan 1 and plan 2. In plan 1, assume there are 5 evaluators and the quota per week for all evaluators may be 50, therefore, each evaluator in the quality plan 1 is expected to complete 10 evaluation tasks in a week (50 evaluation tasks per week/5 evaluators=10 evaluation tasks per week/evaluator). Assume evaluator X under quality plan 1 has actually only completed 8 evaluation tasks during the week, short of the expected 10 evaluation tasks. In plan 2, assume there are 6 evaluators and the quota per week for all evaluators may be 120, therefore, each evaluator in quality plan 2 is expected to complete 20 evaluation tasks in a week. Assume evaluator X under quality plan 2 has actually only completed 16 evaluation tasks during the week, short of the expected 20 evaluation tasks. The off-track % may be computed, using Formula 4 above as (10 expected evaluation tasks+20 expected evaluation tasks)−(8 actual evaluation tasks+16 actual evaluation tasks)/(10 expected evaluation tasks+20 expected evaluations tasks)=20% off-track. Evaluators may have 0% off-track or have negative off-track %, meaning they have completed more evaluations than expected during the proactive correction period, these evaluators are considered on-track.

2. Run and activate the proactive correction engine at the end of a set time period.
3. Create two lists of evaluators, a list of evaluators who are off-track and a list of evaluators which are on-track. Sort the off-track list in descending order, highest off-track % to lowest off-track %. Sort the on-track list in ascending order, lowest off-track % (most negative) to highest off-track % (least negative).
4. Set a counter of evaluations which are reassigned and initialize to 0. reassignedEvaluations=0.
5. From the list of non-empty on-track evaluators (e.g. negative or 0 off-track %), for each evaluator:
a. Pick an evaluator from the list of off-track evaluators with the highest off-track %.
b. Reassign 1 evaluation from the off-track evaluator to the on-track evaluator.
c. Increment the counter of evaluations reassigned: reassignedEvaluations+1
d. Recompute the plan off-track % under the assumption that the on-track evaluator will complete the reassigned evaluation of step b. The plan off-track % is modified to incorporate the reassigned evaluations under the pretense that the on-track evaluators will complete the reassigned evaluations. Therefore, the reassigned evaluations may be added to the expected evaluation tasks completed and the off-track % for the quality plan recalculated. The off-track % may be recalculated according to Formula 5 below:

Plan off-track %=(Expected Evaluation Tasks Completed Per Period+reassignedEvaluations−Actual Evaluation Tasks Completed Per Period)/(Expected Evaluation Tasks Completed Per Period) Formula 5
e. Compare the Plan off-track % from step d to the off-track threshold %.
f. If the plan off-track % is greater than the plan off-track % threshold, then:
   i. Check if the evaluator can take more evaluation tasks by comparing the sum of evaluation tasks completed across all quality plans for this evaluator plus the reassigned evaluations during a proactive correction period to the historical completed evaluation tasks during this period. This is represented by Formula 6:

If ((ΣActual Evaluation Tasks Completed Per Period Per Plan)+reassignedEvaluations)<(Historical Completed Evaluations Per Period*1.05) Formula 6
The reason to use 1.05 factor is to give room for the evaluator to do more work (up to 5% more) than his/her current historical completed evaluation task rate. The factor may be adjusted to allow for any % of buffer. For example, if the evaluator may be able to handle 10% more than his/her actual current historical completed evaluation task rate, the factor may be adjusted to be 1.1.
ii. If in step i the evaluator is determined to be able to take more work, repeat all steps from Step 4.b.
iii. If in step i, the evaluator is determined to be unable to take more work, then remove this evaluator from the list of on-track evaluators and repeat from Step 5.a
g. If the plan off-track % is less or equal to the plan off-track % threshold, then end the loop for the current quality plan and remove the quality plan from the list of off-track plans to the list of on-track quality plans, then repeat from step 1.
   6. Check if the on-track evaluator list is empty. (e.g. on-track evaluator list=null). If the on-track evaluator list is empty and the quality plan is still off-track, perform the following steps to reassign the evaluation tasks to the reserve pool of evaluators:
a. Fetch the reserve pool of evaluators on the quality plan.
b. Create a list of on-track evaluators from the reserve pool of evaluators.
c. Repeat steps 4 and 5 above.
   7. If both the on-track evaluator list and the on-track evaluator list created from the reserve pool of evaluators are empty, and the plan is still off-track. Then log the issues and send a notification to the quality manager about the failure of proactive correction of the quality plan.

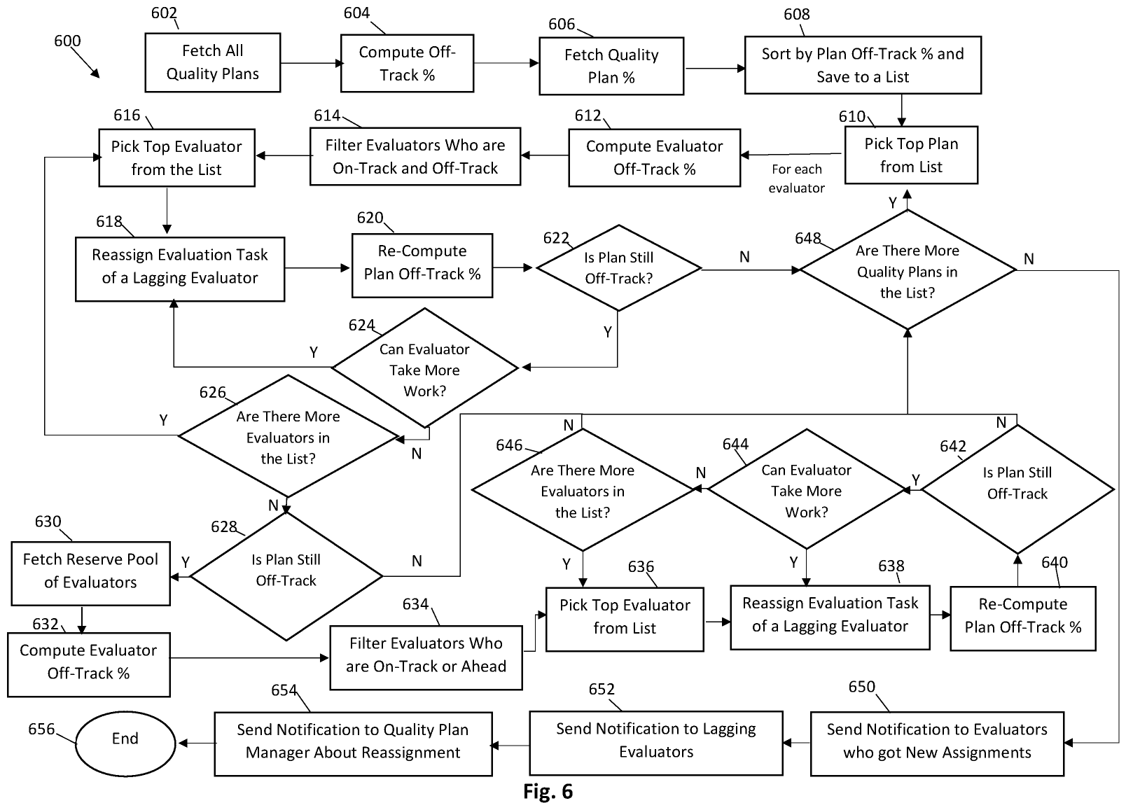

FIG. 6 shows a high-level overview of an example proactive correction algorithm according to embodiments of the invention. Algorithm 600 may include the example proactive correction engine of FIG. 5 and the detailed decision algorithm of operation 540 (e.g. steps 1-7). Algorithm 600 provides a general overview of the example proactive correction engines as described herein. At operation 602, all quality plans in the environment are fetched. For example, the currently active quality plans at company X are fetched and analyzed. At operation 604, the off-track % for each quality plan is computed and then fetched in operation 606. The quality plans are then sorted by plan off-track percentage and then saved to a list in operation 608. The list of quality plans may be saved as a stack, in a first in first out structure, wherein the quality plan with the highest off-track % may be saved near or at the top of the stack. At operation 610, the top (e.g. first on the stack) quality plan may be picked (e.g. chosen) and for each evaluator on the chosen quality plan, an evaluator off-track % may be computed for each evaluator at operation 612.

At operation 614, the evaluators who are determined to be on-track may be selected as part of a list. The evaluators who are determined to be off-track may be placed in either the same sorted list, or an independent list. The list of evaluators may be saved as a stack, in a first in first out structure, wherein the evaluator who may be the foremost on-track is saved near or at the top of the stack of an independent list. The evaluators which are off-track or lagging may similarly be saved as a stack, wherein the evaluator who may be the most off-track is saved near or at the top of the stack in an independent list. In the case that a single sorted list is used, the most on-track evaluator may be sorted at the head of the list whereas the most off-track may be sorted to the tail of the list, vice versa. At operation 616, the most on-track evaluator from the top of the list may then be picked and may be reassigned an evaluation task from an evaluator chosen from the most off-track lagging evaluator list in operation 618. Following the reassignment, the off-track % may then recomputed for the quality plan in operation 620. In operation 622, a determination may be made whether or not the quality plan is still off-track. If the quality plan is no longer off-track, in operation 648, algorithm 600 repeats for another quality plan by picking another off-track quality plan from the top of the quality plans stack, looping to operation 610. If the quality plan is still off-track and if the evaluator picked in operation 618 may take more work (e.g. Formula 6), then the on-track evaluator may be reassigned more evaluation tasks from a lagging evaluator in operation 624 until the quality plan is satisfied (e.g. quality plan becomes on-track). If it is determined in operation 624 the evaluator cannot take more work, in operation 626 the on-track evaluator list may be checked for any additional on-track evaluator which can be reassigned more work, repeating operations 616-622 until the quality plan is on-track. If in operation 626 the on-track evaluator list is exhausted (e.g. empty), then in operation 628, the quality plan is checked to determine if it is still off-track. If the quality plan is no longer off-track, algorithm 600 returns to operation 648.

If it is determined the quality plan is still off-track, then in operation 630, the reserve pool of evaluators may be fetched and added to the list of evaluators. Operations 632-646 are analogous to operations 612-626, with the addition of the reserve pool of evaluators. Finally, at operation 648, if it is determined that no more off-track quality plans exist in the quality plans list, at operation 650, the on-track evaluators that may have been reassigned evaluation tasks are sent notifications that the reassignment occurred. The lagging evaluators, who may have had their evaluation tasks reassigned, may also be sent notifications that the reassignment had occurred in operation 652. Lastly, the quality plan manager is notified of the reassignments in operation 654. At 656, the algorithm ends. Other or different operations may be used.

FIG. 7 shows a high-level block diagram of an exemplary computing device which may be used with embodiments of the present invention. Computing device 700 may include a controller or processor 705 that may be, for example, a central processing unit processor (CPU), a chip or any suitable computing or computational device, an operating system 715, a memory 720, a storage 730, input devices 735 and output devices 740 such as a computer display or monitor displaying for example a computer desktop system.

Operating system 715 may be or may include any code segment designed and/or configured to perform tasks involving coordination, scheduling, arbitration, supervising, controlling or otherwise managing operation of computing device 700, for example, scheduling execution of programs. Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 may be or may include a plurality of, possibly different memory units. Memory 720 may store for example, instructions (e.g. code 725) to carry out a method as disclosed herein, and/or data such as low-level action data, output data, etc.

Executable code 725 may be any executable code, e.g., an application, a program, a process, task or script. Executable code 725 may be executed by controller 705 possibly under control of operating system 715. For example, executable code 725 may be one or more applications performing methods as disclosed herein, for example those of FIGS. 3A-5 according to embodiments of the present invention. In some embodiments, more than one computing device 700 or components of device 700 may be used for multiple functions described herein. For the various modules and functions described herein, one or more computing devices 600 or components of computing device 700 may be used. Devices that include components similar or different to those included in computing device 700 may be used, and may be connected to a network and used as a system. One or more processor(s) 705 may be configured to carry out embodiments of the present invention by for example executing software or code. Storage 730 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as user action data or output data may be stored in a storage 730 and may be loaded from storage 730 into a memory 720 where it may be processed by controller 705. In some embodiments, some of the components shown in FIG. 7 may be omitted.

Input devices 735 may be or may include a mouse, a keyboard, a touch screen or pad or any suitable input device. It will be recognized that any suitable number of input devices may be operatively connected to computing device 700 as shown by block 735. Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700, for example, a wired or wireless network interface card (NIC), a modem, printer or facsimile machine, a universal serial bus (USB) device or external hard drive may be included in input devices 735 and/or output devices 740.

Embodiments of the invention may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention may improve the technologies of quality assurance and planning by using automated preventive and/or proactive mechanisms to ensure a quality plan stays on-track. The combination of the computer based preventive forecasting and proactive corrections improves quality plan technology, helping to meet a target evaluation task completion target of a quality plan and save it from failing. “Intelligence” is therefore added to quality plan technology to predict failures during setup and auto correct quality plans after they have been turned on. The preventive and proactive mechanism do this using analytics on historical data of interactions and evaluations, periodically updating and feeding back this information. The combination of these mechanism allow for an automated quality management

Embodiments described herein may result in a successful quality assurance process with a maximum return on investment.

One skilled in the art will realize the invention may be embodied in other specific forms without departing from the spirit or essential characteristics thereof. The embodiments described herein are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Descriptions of embodiments of the invention in the present application are provided by way of example and are not intended to limit the scope of the invention. The described embodiments include different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A computer implemented method for performing quality assurance, the method comprising:
receiving, by a processor, a quality plan comprising an expected number of evaluation tasks, wherein each evaluation task is distributed to an evaluator of a plurality of evaluators to be completed;
computing, by the processor, for each evaluator, an expected number of evaluation tasks completed per period, wherein the expected number of evaluation tasks completed per period is based on the expected number of evaluation tasks averaged over a set time period;
receiving, by the processor, for each evaluator, a number of actual evaluation tasks completed during the set time period; and
for each evaluator, reassigning, by the processor, one or more evaluation tasks from the evaluator if the actual evaluation tasks completed during the set time period for said evaluator does not meet a predetermined threshold value.

2. The method of claim 1, wherein the predetermined threshold value is a percent shortfall between the expected number of evaluation tasks completed per period over and the actual evaluation tasks completed during the set time period.

3. The method of claim 1, wherein reassigning the one or more evaluation tasks from the evaluator includes reassigning to a reserve pool of evaluators if an aggregate sum of reassignments is less than the percent shortfall.

4. The method of claim 1, wherein reassigning the one or more evaluation tasks from the evaluator includes using an adjustable buffer, wherein the buffer is an added percentage of the number of actual evaluation tasks completed during the set time period added to the number of actual evaluation tasks completed during the set time period.

5. The method of claim 1, wherein the method further comprising notifying and displaying the reassigning of the evaluation tasks in a graphical user interface.

6. A computer implemented method for quality plan optimization, the method comprising:
receiving, by a processor, a quality plan comprising:
a plurality of identifications of agents, each agent associated with one of a plurality of interactions,
each identification of agent assigned an interactions count number, and
a plurality of filters associated with a plurality of interactions;
calculating, by the processor, for each identification of agent, a filtered number of interactions associated with said identification of agent; and
if the filtered number of interactions is less than the interactions count number, adding, by the processor, the identification of agent to a list of agents not meeting the quality plan.

7. The method of claim 6, wherein calculating a filtered number of interactions further comprises filters selected by a brute force algorithm, the brute force algorithm comprising:
receiving, by the processor, the plurality of filters;
calculating, by the processor, for each filter, the filtered number of interactions associated with each identification of agent; and
if the filtered number of interactions for each filter is greater than the interactions count number, then adding, by the processor, the filter to the quality plan.

8. The method of claim 7, wherein if the filtered number of interactions for each filter is less than the interactions count number, then not adding, by the processor, the filter to the quality plan.

9. A system for performing quality assurance, the system comprising:
a memory;
a processor configured to:
receive a quality plan comprising an expected number of evaluation tasks, wherein each evaluation task is distributed to an evaluator of a plurality of evaluators to be completed;
compute for each evaluator, an expected number of evaluation tasks completed per period, wherein the expected number of evaluation tasks completed per period is based on the expected number of evaluation tasks averaged over a set time period;
receive for each evaluator, a number of actual evaluation tasks completed during the set time period; and
reassign, for each evaluator, one or more evaluation tasks from the evaluator if the actual evaluation tasks completed during the set time period for said evaluator does not meet a predetermined threshold value.

10. The system of claim 9, wherein the predetermined threshold value is a percent shortfall between the expected number of evaluation tasks completed per period over and the actual evaluation tasks completed during the set time period.

11. The system of claim 9, wherein the processor is configured to reassign the one or more evaluation tasks from the evaluator includes reassigning to a reserve pool of evaluators if an aggregate sum of reassignments is less than the percent shortfall.

12. The system of claim 9, wherein the processor is configured to reassign the one or more evaluation tasks from the evaluator includes using an adjustable buffer, wherein the buffer is an added percentage of the number of actual evaluation tasks completed during the set time period added to the number of actual evaluation tasks completed during the set time period.

13. The system of claim 9, wherein the processor is further configured to notify and display the reassigning of the evaluation tasks in a graphical user interface.

14. A system for quality plan optimization, the system comprising:
a memory; and
a processor configured to:
receive a quality plan comprising:
a plurality of identifications of agents, each agent associated with one of a plurality of interactions,
each identification of agent assigned an interactions count number, and
a plurality of filters associated with a plurality of interactions;
calculate for each identification of agent, a filtered number of interactions associated with said identification of agent; and
if the filtered number of interactions is less than the interactions count number, add the identification of agent to a list of agents not meeting the quality plan.

15. The system of claim 14, wherein the processor is configured to calculate a filtered number of interactions further comprises filters selected by a brute force algorithm, the brute force algorithm comprising:
receiving, by the processor, the plurality of filters;
calculating, by the processor, for each filter, the filtered number of interactions associated with each identification of agent; and
if the filtered number of interactions for each filter is greater than the interactions count number, then adding, by the processor, the filter to the quality plan.

16. The system of claim 14, wherein the processor is configured to not add the filter to the quality plan if the filtered number of interactions for each filter is less than the interactions count number.

17. A computer implemented method for performing quality assurance, the method comprising:
receiving, by a processor, a quality plan comprising a number of interactions to be evaluated, wherein each interaction is to be completed by an evaluator;
calculating, by the processor, for each evaluator, an interactions completion rate, wherein the interactions completion rate is the number of interactions to be evaluated averaged over a period of time;
receiving, by the processor, for each evaluator, a number of actual completed interactions; and
reassigning, by the processor, one or more interactions from an evaluator if the interactions completion rate for the evaluator does not meet a predetermined threshold value.

18. The method of claim 17, wherein the predetermined threshold value is the difference between the interactions completion rate and the rate of the number of actual completed interactions.

19. The method of claim 17, wherein reassigning the one or more interactions from the evaluator comprises reassigning to a reserve pool of evaluators if an aggregate sum of reassignments is less than the difference.

20. The method of claim 17, wherein reassigning the one or more interactions from the evaluator includes using a buffer, wherein the buffer is an added percentage of the number of actual evaluation tasks completed during the set time period added to the number of actual evaluation tasks completed during the set time period.
